(19) United States
(12) Patent Application Publication
(10) Pub. No.: US 2025/0389184 A1
(43) Pub. Date: Dec. 25, 2025

(54) DOWNHOLE PRESSURE AND FLOW RATE ESTIMATION

(71) Applicant: Chevron U.S.A. Inc., San Ramon, CA (US)

(72) Inventors: Lisa Ann Brenskelle, Houston, TX (US); Pamela I. Chacon, San Ramon, CA (US)

(21) Appl. No.: 18/868,135

(22) PCT Filed: May 18, 2023
(86) PCT No.: PCT/US2023/022719

§ 371 Date: Nov. 21, 2024

Related U.S. Application Data
(60) Provisional application No. 63/344,615, filed on May 22, 2022.

(51) Int. Cl. E21B 47/107; E21B 43/14; E21B 47/07; E21B 47/103

(52) U.S. Cl. CPC E21B 47/107; E21B 47/07; E21B 47/103; E21B 43/14

(57) ABSTRACT

A method of determining wellbore pressures and multiphase fluid flow rates includes obtaining an average temperature and an average speed of sound in a section of the wellbore. The method further includes calculating phase mass flow rates of the multiphase fluid through the section at least based on the average temperature, the average speed of sound, an estimated pressure at an estimated-pressure location in the wellbore, and a difference between a known pressure and the estimated pressure. The method also includes calculating a total mass flow rate of the multiphase fluid through the section based on the phase mass flow rates of the multiphase fluid. The phase mass flow rates and the total mass flow rate of the multiphase fluid are calculated iteratively by adjusting the estimated pressure until the total mass flow rate is within a threshold value of a known total mass flow rate of the multiphase fluid.

### CROSS-REFERENCE TO RELATED APPLICATIONS

The present application claims the benefit of U.S. Provisional Application No. 63/344,615, entitled “DOWNHOLE PRESSURE AND FLOW RATE ESTIMATION” which was filed on: May 22, 2022, the entirety of which is hereby incorporated herein by reference.

### FIELD

The present disclosure generally relates to estimating downhole pressure and flow rate.

### BACKGROUND

In oil and gas industry, information about a wellbore can be valuable in managing and improving production. For example, pressure information can be important for proper management of a wellbore. As another example, in a wellbore that has multiple producing zones, knowledge of fluid flow rates through the different producing zones may be important. Typically, downhole tools are used to obtain downhole information from a wellbore. For example, pressure sensors and flow meters may be used to obtain pressure and flow rate, respectively. However, in many cases, the number of downhole pressure sensors and flow meters may be limited due to, for example, cost constraints and/or challenges of placing multiple devices in a wellbore and at desired locations. In some cases, the information gathered from such equipment may be unreliable, for example, due to equipment degradation or failure. Thus, a solution that enables estimating downhole pressure and flow rates cost effectively and efficiently may be desirable.

### SUMMARY

The present disclosure generally relates to estimating downhole pressure and flow rate. In an example embodiment, a method of determining wellbore pressures and multiphase fluid flow rates includes obtaining an average temperature of a multiphase fluid and an average speed of sound in the multiphase fluid in a section of the wellbore. The method further includes calculating phase mass flow rates of the multiphase fluid through the section at least based on the average temperature, the average speed of sound, an estimated pressure at an estimated-pressure location in the wellbore, and a difference between a known pressure and the estimated pressure. The method also includes calculating a total mass flow rate of the multiphase fluid through the section based on the phase mass flow rates of the multiphase fluid. The calculating the phase mass flow rates of the multiphase fluid through the section and the calculating the total mass flow rate of the multiphase fluid through the section include iteratively calculating the phase mass flow rates of the multiphase fluid and the total mass flow rate of the multiphase fluid by adjusting the estimated pressure until the total mass flow rate is within a threshold value of a known total mass flow rate of the multiphase fluid.

In another example embodiment, a system for determining wellbore pressures and multiphase fluid flow rates includes a temperature sensor configured to measure temperature for use in determining an average temperature of a multiphase fluid in a section of the wellbore. The system further includes an acoustic sensor configured to measure sound for use in determining an average speed of sound in the multiphase fluid in the section of the wellbore. The system also includes a computing device configured to calculate phase mass flow rates of the multiphase fluid through the section at least based on the average temperature, the average speed of sound, an estimated pressure at an estimated-pressure location in the wellbore, and a difference between a known pressure and the estimated pressure. The computing device is further configured to calculate a total mass flow rate of the multiphase fluid through the section based on the phase mass flow rates of the multiphase fluid. The computing device is configured to calculate the phase mass flow rates of the multiphase fluid and the total mass flow rate of the multiphase fluid by iteratively calculating the phase mass flow rates of the multiphase fluid and the total mass flow rate of the multiphase fluid by adjusting the estimated pressure until the total mass flow rate is within a threshold value of a known total mass flow rate of the multiphase fluid.

These and other aspects, objects, features, and embodiments will be apparent from the following description and the claims.

### BRIEF DESCRIPTION OF THE DRAWINGS

Various aspects of the invention will now be described with reference to the following figures in which the same reference numerals are used to designate corresponding parts throughout each of the several views.

FIG. 1 illustrates a system for estimating downhole pressure and flow rate according to an example embodiment;

FIGS. 2A and 2B illustrate a method including steps for calculating total mass flow rate based on estimated pressure according to an example embodiment;

FIG. 3 illustrates the system of FIG. 1 and multiple sections of the wellbore according to an example embodiment;

FIG. 4 illustrates the system of FIG. 1 and multiple sections of the wellbore according to another example embodiment;

FIG. 5 illustrates the system of FIG. 1 and multiple sections of the wellbore according to another example embodiment;

FIG. 6 illustrates a block diagram of the pressure and flow rate estimation computing device of FIG. 1 according to an example embodiment; and

FIG. 7 illustrates a method for estimating pressure and flow rates of a multiphase fluid flowing through a wellbore according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding but not necessarily identical elements.

### DETAILED DESCRIPTION OF THE EMBODIMENTS

In general, known values of pressure and total mass flow rate of a multiphase fluid at a location (e.g., at the wellhead or a downhole location) can be used to estimate pressure and flow rate at downhole locations related to producing zones of a wellbore. The known pressure and total mass flow rate may be determined through measurement or other means. For example, typically, pressure and mass flow rate of a multiphase fluid can be measured at the wellhead or at other locations of a wellbore using a pressure sensor and a flow meter, respectively. In some cases, the total mass flow rate at the wellhead can be determined by using a choke equation/correlation, well testing, or other surface method as can be readily understood by those of ordinary skill in the art. To illustrate, pressure difference across the choke, fluid temperature at the wellhead, choke percentage, and fluid composition are parameters required to use a choke equation (i.e., valve design equation) or appropriate choke correlation, which depends on valve, fluids, and other factors, to calculate bulk volumetric flow rate at the wellhead.

In some example embodiments, a wellbore may be considered in terms of one or more sections for the purpose of determining/estimating pressure and flow rates at downhole locations. In general, sections of a wellbore are defined based on the locations of producing zones of the wellbore, where an individual section is defined to have at least one producing zone. Some sections can overlap with each other, and pressure and flow rates determined with respect to one section may be used as known pressure and flow rates, respectively, to estimate pressure and flow rates with respect to another section.

In general, methods of determining downhole pressure described herein with respect to a section of a wellbore may include determining pressure at a downhole location by iteratively changing an estimated pressure at the downhole location until the estimated pressure yields a calculated total mass flow rate that is within an acceptable threshold of a known total mass flow rate. The estimated pressure (“final estimated pressure”) that yields the calculated total mass flow rate that is within an acceptable threshold is designated as the pressure at the downhole location.

When multiple sections are evaluated simultaneously, at each iteration to determine the pressure at the downhole location with respect to a first section, the estimated pressure may be simultaneously used to calculate phase mass flow rates and a total mass flow rate through an adjacent section. With respect to the adjacent section, the calculated phase mass flow rates and total mass flow rate that are simultaneously calculated with the final estimated pressure at the downhole location are determined as the phase mass flow rates and total mass flow rate through the adjacent section. In some alternative embodiments, the phase mass flow rates and total mass flow rate may be calculated for the adjacent section after the final estimated pressure at the downhole location is determined with respect to the first section.

Methods and systems of estimating pressure and flow rates described herein apply to a well-mixed multiphase fluid flowing through a wellbore. Characterizations, such as pressure volume temperature (PVT) characterization, speed of sound characterization, and other characterizations, of the multiphase fluid flowing through the wellbore are performed to enable determining some parameters used in the methods described herein as can be readily understood by those of ordinary skill in the art. In general, some parameters (e.g., pressure and temperature of the multiphase fluid at the wellhead) used in the methods described herein may be measured as can be readily understood by those of ordinary skill in the art.

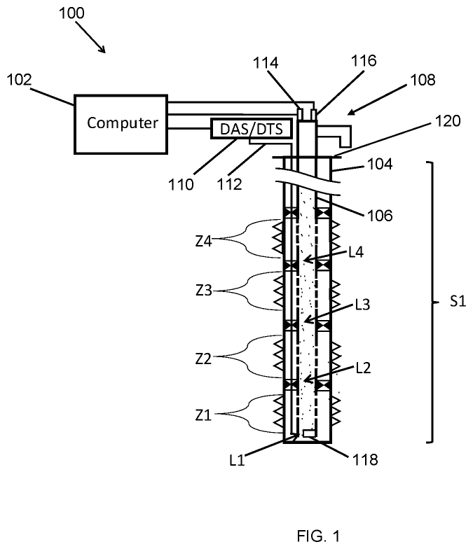

Turning to the drawings, FIG. 1 illustrates a system 100 for estimating downhole pressure and flow rate according to an example embodiment. In some example embodiments, the system 100 includes a pressure and flow rate estimation computing device 102 configured to estimate pressure and mass flow rate values at different locations in a wellbore 104. The computing device 102 may be a computer, a portable device, etc. The wellbore 104 may have multiple producing zones Z1, Z2, Z3, Z4, and production tubing 106 may extend into the wellbore 104 between the wellhead 108 and the bottom of the wellbore 104. The computing device 102 may be located at an oil/gas production platform (e.g., a rig) above the wellbore 104 or at a remote location as can be readily understood by those of ordinary skill in the art.

In some example embodiments, the system 100 may also include a distributed sensing system 110 that uses one or more fiber optic cables 112 extending into the wellbore 104 to determine wellbore parameters. The distributed sensing system may be permanently installed in the well, or temporarily deployed there for the purpose of periodic measurement of wellbore parameters. For example, the distributed sensing system 110 may include a distributed acoustic sensing (DAS) device and a distributed temperature sensing (DTS) device as can be readily understood by those of ordinary skill in the art. To illustrate, the DAS device in the distributed sensing system 110 may be used to measure sound, and the measured sound may be used by the DAS device or another device (e.g., the computing device 102) to determine speed of sound in the fluid in the wellbore, and the DTS device may be used to determine temperature of the fluid at various locations in the wellbore 104. The distributed sensing system 110 may be communicably coupled to the computing device 102 and may provide information such as measured temperature and sound to the computing device 102. For example, the computing device 102 may determine average temperature and average speed of sound of fluid in sections of the wellbore 104 based on the measured temperature and sound values received from the distributed sensing system 110. Alternatively, the distributed sensing system 110 may determine average temperature and average speed of sound for sections of the wellbore 104 and provide the information to the computing device 102.

In some example embodiments, the system 100 may include a pressure sensor 114 and a flow meter 116 at a wellhead 108. The pressure sensor 114 may be used to determine pressure at the wellhead 108 (Pwh), and the flow meter 116 may be used to measure or otherwise determine the total mass flow rate of the multiphase fluid at the wellhead 108 (Mtotwh) and phase mass flow rates at the wellhead 108. The pressure sensor 114 and the flow meter 116 may be communicably coupled to the computing device 102 and may provide pressure and flow rate measurements to the computing device 102. As described above, in some alternative embodiments, choke equation/correlation, well testing, or other surface method may be used instead of the flow meter 116 to determine total flow rate and phase mass flow rates at the wellhead as can be readily understood by those of ordinary skill in the art.

In some example embodiments, the system 100 may also include a pressure sensor 118 at the bottom of the wellbore 104 designated location L1 for illustrative purposes. The pressure sensor 118 is positioned to measure bottom hole pressure (BHP) and send the BHP information to the computing device 102 via one or more communication methods known to those of ordinary skill in the art. In some alternative embodiments, the pressure sensor 118 may be omitted or may be at a different location.

In some example embodiments, the system 100 may be used to estimate pressure at various downhole locations, such as L1, L2, L3, L4. For example, when the pressure sensor 118 is omitted or determined to be defective, the system 100 may be used to estimate the BHP at the location L1. In some embodiments, after the BHP at the location L1 is determined, the system 100 may use the BHP to estimate the pressure at one or more of the locations L2, L3, L4 as explained below. Alternatively, all unknown pressures may be estimated simultaneously.

In some example embodiments, the entire wellbore 104 may be treated as a single section S1 for the purpose of determining BHP. With respect to the section S1, the computing device 102 may determine the BHP at the location L1 by iteratively estimating BHP and determining a calculated total mass flow rate through the section S1 until the estimated BHP yields a calculated total mass flow rate through the section S1 that is within an acceptable threshold (e.g., 5%) of the known total flow rate at the wellhead 108 (Mtotwh).

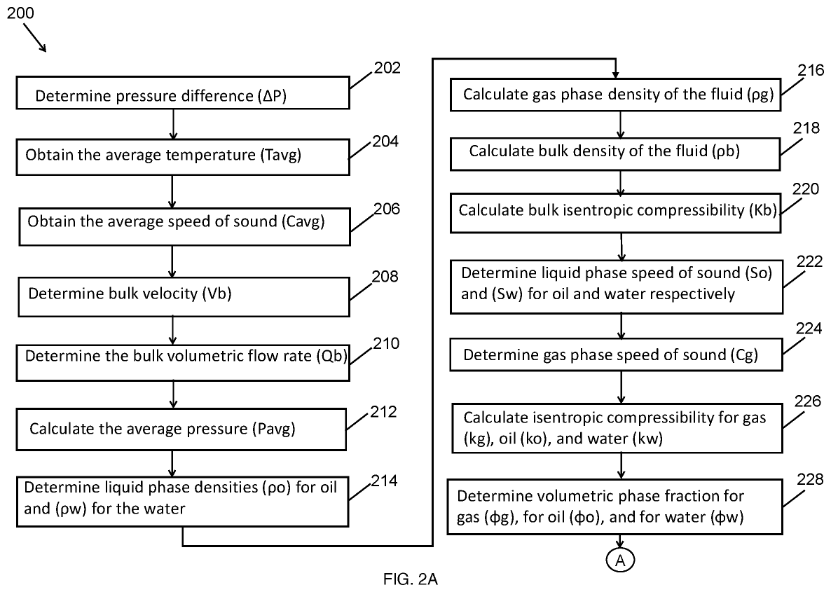

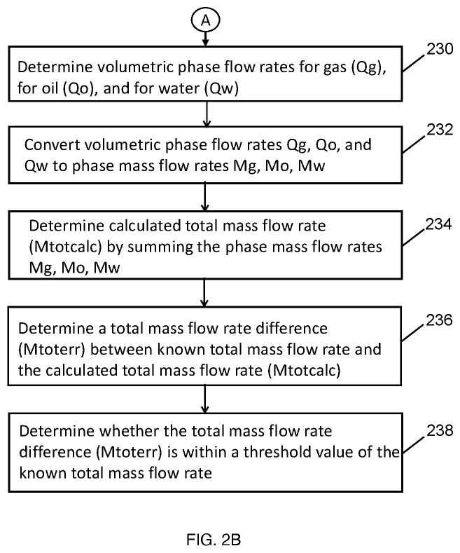

To illustrate, FIGS. 2A and 2B illustrate a method 200 that includes steps 202-238 for calculating total mass flow rate based on estimated pressure according to an example embodiment. Referring to FIGS. 1, 2A, and 2B, in general, the computing device 102 executes step 202 of the method 200 using a known pressure and an estimated pressure. With respect to the section S1 defined by the wellhead 108 and the bottom of the wellbore 104, the pressure at the wellhead 108 (Pwh) is a known pressure, and the BHP at the bottom of the wellbore 104 is an estimated pressure that can be iteratively updated as described below. The bottom of the wellbore 104 (i.e., the location L1) is considered an estimated-pressure location with respect to the section S1.

At step 202 of the method 200, the computing device 102 calculates the pressure difference (ΔP) across the section S1, i.e., calculate BHP−Pwh. For the BHP, an initial estimate may be made, for example, based on BHP values measured for other wellbores that are similar to the wellbore 104, based on modeling, based upon reservoir pressure estimates, etc.

In some example embodiments, at step 204, the computing device 102 may obtain the average temperature (Tavg) (i.e., average temperature of the multiphase fluid) along the section S1 (i.e., the entire wellbore 104). For example, the computing device 102 may determine the average temperature (Tavg) or obtain, directly or indirectly, the average temperature (Tavg) from the DTS of the distributed sensing system 110. To illustrate, the computing device 102 may obtain the average temperature (Tavg) from data storage (e.g., a memory device). For example, the average temperature (Tavg) may have been determined by the computing device 102 based on sensor data from the distributed sensing system 110 and stored in the memory device of the computing device 102.

In some example embodiments, at step 206, the computing device 102 may obtain the average speed of sound (Cavg) (i.e., the average speed of sound in the multiphase fluid) along the section S1. For example, the computing device 102 may determine the average speed of sound (Cavg) or obtain, directly or indirectly, the average speed of sound (Cavg) from the DAS of the distributed sensing system 110. Alternatively, the computing device 102 may obtain the average speed of sound (Cavg) from data storage (e.g., a memory device).

In some example embodiments, at step 208, the computing device 102 may determine bulk velocity (V_{b}) of the multiphase fluid through the section S1 from the difference between the average speed of sound (Cavg) in the fluid along the section S1 in the direction of fluid flow and the average speed of sound in the fluid along the section S1 opposite the direction of fluid flow. For example, the bulk velocity (Vb) may be determined by solving for 2V_{b}=(C_{forward}−Cᵣₑᵥₑᵣₛₑ), where ‘forward’ refers to direction of fluid flow and where ‘reverse’ refers to opposite direction of fluid flow. At step 210, using the bulk velocity (V_{b}) for the section S1 and the geometry (i.e., the cross-sectional area A) of the production tubing 106, the computing device 102 may determine the bulk volumetric flow rate (Q_{b}) through the section S1. For example, the computing device 102 may use Equation 1 to calculate the bulk volumetric flow rate (Q_{b}) through the section S1.

$${Q}_{b} = {V}_{b} \cdot A \qquad Eq . l$$

At step 212, using the pressure at the wellhead 108 (Pwh), which is known, and an estimated value for the BHP, the computing device 102 may calculate the average pressure (Pavg) for section S1. At step 214, using the average temperature (Tavg) for the section S1 and the characterization of the multiphase fluid flowing through the wellbore 104, the computing device 102 may determine liquid phase density for the oil component of the multiphase fluid (ρo) and for the water component of the multiphase fluid (ρw) as can be readily understood by those of ordinary skill in the art. At step 216, using the average temperature (Tavg) and the average pressure (Pavg) for the section S1 as well as the characterization of the multiphase fluid flowing through the wellbore 104, the computing device 102 may determine gas phase density (ρg) for the gas component of the multiphase fluid as can be readily understood by those of ordinary skill in the art.

In some example embodiments, at step 218, the computing device 102 may calculate the bulk density (ρb) using Equation 2:

$${ρ}_{b} = \frac{Δ P}{\frac{gh + {LfVb}^{2}}{4 r}} \qquad Eq . 2$$

In Equation 2, h=height of column of fluid, g=gravity, L=length of pipe, r=radius of pipe and f=fanning friction factor. Note that Equation 2 assumes a vertical wellbore, although other wellbore configurations are contemplated as can be readily understood by those of ordinary skill in the art with the benefit of this disclosure. The Fanning friction factor is defined by Equation 3:

$$f = f ( {R}_{e} , ε ) where {R}_{e} = \frac{{ρ}_{b} {v}_{b} L}{{μ}_{b}} \qquad Eq . 3$$

In Equation 3, ε=pipe roughness.

In Equation 2, an assumed value of the Fanning friction factor may be used as readily understood by those of ordinary skill in the art. In some alternative embodiments, the Fanning friction factor may be revised based on fluid property information as can be readily understood by those of ordinary skill in the art.

At step 220, the computing device 102 may calculate bulk isentropic compressibility (kb) of the fluid with respect to the section S1 using Equation 4:

$${k}_{b} = \frac{1}{{p}_{b} {C}_{avg}^{2}} \qquad Eq . 4$$

At step 222, using the average temperature (Tavg) for the section S1, the computing device 102 may determine liquid phase speed of sound for oil (Co) and liquid phase speed of sound for water (Cw) through the section S1 as can be readily understood by those of ordinary skill in the art. At step 224, using the average temperature (Tavg) and the average pressure (Pavg) for the section S1, the computing device 102 may determine the gas phase speed of sound (Cg) through the section S1 as can be readily understood by those of ordinary skill in the art. At step 226, the computing device 102 may calculate isentropic compressibility for gas (k_{g}), oil (kₒ), and water (k_{w}) phases using Equations 5a, 5b, and 5c, respectively.

$${k}_{g} = \frac{1}{{p}_{g} {C}_{g}^{2}} \qquad Eq . 5 a$$

$${k}_{o} = \frac{1}{{p}_{o} {C}_{o}^{2}} \qquad Eq . 5 b$$

$${k}_{w} = \frac{1}{{p}_{w} {C}_{w}^{2}} \qquad Eq . 5 c$$

At step 228, the computing device 102 may determine volumetric phase fraction for gas (φ_{g}), for oil (φₒ), and for water (φ_{w}) by solving Equations 6 and 7 simultaneously.

$${ρ}_{b} = {φ}_{g} {ρ}_{g} + {φ}_{o} {ρ}_{o} + ( 1 - {φ}_{o} - {φ}_{g} ) {ρ}_{w} \qquad Eq . 6$$

$${k}_{b} = {φ}_{g} {k}_{g} + {φ}_{o} {k}_{o} + ( 1 - {φ}_{o} - {φ}_{g} ) {k}_{w} \qquad Eq . 7$$

At step 230, the computing device 102 may determine volumetric phase flow rates for gas (Q_{g}), for oil (Qₒ), and for water (Q_{w}) based on the bulk volumetric flow rate (Q_{b}) calculated using Equation 1 and the volumetric phase fractions (φ_{g}), (φₒ), and (φ_{w}) determined using Equations 6 and 7. To illustrate, Equations 8a, 8b, 8c can be used to calculate the gas volumetric phase flow rate (Q_{g}), the oil volumetric phase flow rate (Qₒ), and the water volumetric phase flow rate (Q_{w}).

$${Q}_{g} = {Q}_{b} {φ}_{g} \qquad Eq . 8 a$$

$${Q}_{o} = {Q}_{b} {φ}_{o} \qquad Eq . 8 b$$

$${Q}_{w} = {Q}_{b} {φ}_{w} \qquad Eq . 8 c$$

At step 232, the computing device 102 may convert the volumetric phase flow rates (Q_{g}), (Qₒ), and (Q_{w}) to phase mass flow rates M_{g}, Mₒ, M_{w} using Equations 9a, 9b, and 9c, respectively.

$${M}_{g} = {Q}_{b} {ρ}_{g} \qquad Eq . 9 a$$

$${M}_{o} = {Q}_{b} {ρ}_{o} \qquad Eq . 9 b$$

$${M}_{w} = {Q}_{b} {ρ}_{w} \qquad Eq . 9 c$$

At step 234, the computing device 102 may determine calculated total mass flow rate (Mtotcalc) for the section S1 by summing the three phase mass flow rates, M_{g}, Mₒ, M_{w}, determined using Equations 9a, 9b, and 9c, respectively. At step 236, the computing device 102 may determine a total mass flow rate difference (Mtoterr) between the known total mass flow rate (Mtotwh), which is known for example through measurement, and the calculated total mass flow rate (Mtotcalc), which is calculated as described above. At step 238, the computing device 102 may determine whether the total mass flow rate difference (Mtoterr) is within a threshold value (e.g., 5%) of the known total mass flow rate (Mtotwh).

In some example embodiments, if the total mass flow rate difference (Mtoterr) is outside of the threshold, the computing device 102 may change the estimated BHP up or down depending on the sign of the total mass flow rate difference (Mtoterr) as can be readily understood by those of ordinary skill in the art. After the estimated BHP is updated, the computing device 102 may repeat steps 202-238 of the method 200 until the total mass flow rate difference (Mtoterr) is within a threshold value. If the total mass flow rate difference (Mtoterr) is within a threshold value (e.g., 5%) of the known total mass flow rate (Mtotwh) following the execution of the steps 202-238, the computing device 102 may designate the estimated BHP used in the particular execution as the final estimated BHP.

By performing the method 200, the computing device 102 can estimate the BHP of the wellbore 104 within an acceptable range of the actual BHP. For example, the ability to reliably estimate the BHP when the pressure sensor 118 is omitted or when the information from the pressure sensor 118 is unreliable can be beneficial.

In some alternative embodiments, the computing device 102 and the distributed sensor system 110 may be integrated in a single device without departing from the scope of this disclosure. In some alternative embodiments, the computing device 102 may be communicably coupled to the distributed sensor system 110, the pressure sensor 114, and the flow meter 116 in a different configuration than shown in FIG. 1 without departing from the scope of this disclosure. In some alternative embodiments, another means of determining fluid flow may be used instead of or in addition to the flow meter 116 without departing from the scope of this disclosure. In some alternative embodiments, methods other than distributed sensing may be used to obtain downhole temperature and/or acoustic information as can be readily understood by those of ordinary skill in the art. For example, the distributed sensor system 110 may be omitted or replaced by another temperature and/or acoustic device or system. In embodiments where the system 100 includes the pressure sensor 118 and the pressure information from the pressure sensor 118 is considered reliable, the computing device 102 may not execute the method 200 with respect to the section S1. Instead, the BHP as measured by the pressure sensor 118 may be used as a known pressure in the executing of the method 200 with respect to sections that include the zone Z1.

In some alternative embodiments, the wellbore 104 may include more or fewer than four producing zones without departing from the scope of this disclosure. Although the wellbore 104 is shown as a vertical wellbore, in some alternative embodiments, the wellbore 104 may be a horizontal or deviated wellbore without departing from the scope of this disclosure. In some alternative embodiments, the method 200 may include different and/or more or fewer steps than shown in FIGS. 2A and 2B without departing from the scope of this disclosure. In some alternative embodiments, some of the steps of the method 200 may be performed in a different order than described without departing from the scope of this disclosure.

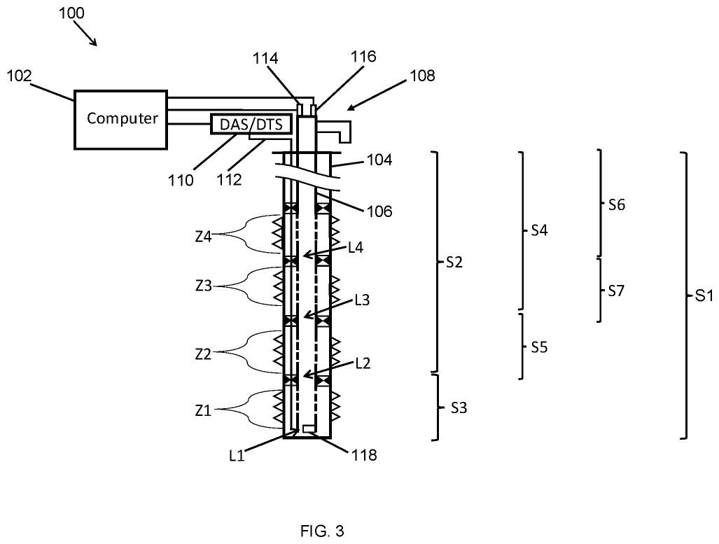

FIG. 3 illustrates the system 100 of FIG. 1 and multiple sections S1, S2, S3, S4, S5, S6, S7 of the wellbore 104 according to an example embodiment. Referring to FIGS. 1-3, in some example embodiments, the computing device 102 may determine the pressure at locations L2, L3, L4 (estimated-pressure locations) and phase mass flow rates through each of the sections S1, S2, S3, S4, S5, S6, S7 by executing the method 200 in substantially the same manner described above with respect to the section S1 and FIG. 1. In some alternative embodiments, the section S1 in FIG. 3 may be omitted if the pressure information from the pressure sensor 118 is reliable.

In some example embodiments, the sections S1, S2, S3, S4, S5, S6, S7 are defined to enable estimating pressure and flow rates through the wellbore 104 and particularly with respect to the producing zones Z1, Z2, Z3, Z4. For example, the sections S2 and S4 include multiple producing zones, and the sections S3, S5, S6, S7 each include a single producing zone. To illustrate, the section S2 includes the producing zones Z2, Z3, and Z4, and the section S4 includes the producing zones Z3 and Z4. The section S3 includes the producing zone Z1. The section S5 includes the producing zone Z2. The section S6 includes the producing zone Z4. The section S7 includes the producing zone Z3.

The section S2 is defined by the wellhead 108 and the estimated-pressure location L2. The section S3 is defined by the estimated-pressure location L2 and the known pressure location L1 (i.e., the bottom of wellbore 104, measured by pressure sensor 118). The section S4 is defined by the wellhead 108 and the estimated-pressure location L3. The section S5 is defined by the estimated-pressure location L3 and the estimated-pressure location L2. The section S6 is defined by the wellhead 108 and the estimated-pressure location L4. The section S7 is defined by the estimated-pressure location L4 and the estimated-pressure location L3.

In some example embodiments, the computing device 102 executes steps 202 and 212 of the method 200 with respect to the sections S2, S3, S4, S5, S6, S7 based on a known pressure and an estimated pressure. With respect to the section S2, the pressure at the wellhead 108 (Pwh) is a known pressure, and the pressure at the location L2 is an estimated pressure that can be iteratively updated. With respect to the section S3, the BHP at the bottom of the wellbore 104 (i.e., at the location L1) is a known pressure (e.g., determined with respect to the section S1 or measured by the pressure sensor 118), and the pressure at the location L2 is the same estimated pressure used with respect to the section S2. With respect to the section S4, the pressure at the wellhead 108 (Pwh) is a known pressure, and the pressure at the location L3 is an estimated pressure that can be iteratively updated. With respect to the section S5, the pressure at the location L2 is considered a known pressure (e.g., determined with respect to the section S2), and the pressure at the location L3 is the same estimated pressure used with respect to the section S4. With respect to the section S6, the pressure at the wellhead 108 (Pwh) is a known pressure, and the pressure at the location L4 is an estimated pressure that can be iteratively updated. With respect to the section S7, the pressure at the location L3 is considered as a known pressure (e.g., determined with respect to the section S4), and the pressure at the location L4 is the same estimated pressure used with respect to the section S6.

In some example embodiments, the computing device 102 may execute step 236 of the method 200 based on the known total mass flow rate at the wellhead 108 (Mtotwh). To illustrate, with respect to the sections S2, S4, and S6 that are defined by the wellhead 108, the computing device 102 may execute step 236 of the method 200 based on the known total mass flow rate at the wellhead 108 (Mtotwh).

To illustrate, in some example embodiments, the computing device 102 may determine the pressure at the location L2 and the phase mass flow rates through the section S2 of the wellbore 104 based on the known pressure at the wellhead 108 (Pwh) and the known (e.g., measured) total mass flow rate of the multiphase fluid at the wellhead 108 (Mtotwh) by executing the steps 202-238 of the method 200. At step 202 of the method 200, using the known pressure at the wellhead (Pwh) and an estimated value for the pressure at the location L2 (PL2) (i.e., the location L2 being an estimated-pressure location with respect to the section S2), the computing device 102 may calculate the pressure difference (ΔP) across the section S2, i.e., calculate PL2−Pwh. For example, the initial estimate for the pressure at the location L2 (PL2) may be selected based on the known pressure at the wellhead 108 (Pwh) and the BHP determined with respect to the section S1, for example, by interpolation.

In some example embodiments, at step 204, the computing device 102 may obtain the average temperature (Tavg) along the section S2 of the wellbore 104. For example, the computing device 102 may determine the average temperature (Tavg) or obtain, directly or indirectly, the average temperature (Tavg) from the DTS of the distributed sensing system 110. To illustrate, the computing device 102 may obtain the average temperature (Tavg) from data storage (e.g., a memory device). For example, the average temperature (Tavg) may have been determined by the computing device 102 based on sensor data from the distributed sensing system 110 and stored in the memory device of the computing device 102.

In some example embodiments, at step 206, the computing device 102 may obtain the average speed of sound (Cavg) in the fluid along the section S2. For example, the computing device 102 may obtain the average speed of sound (Cavg) in the fluid from the DAS of the distributed sensing system 110. Alternatively, the computing device 102 may obtain the average speed of sound (Cavg) from data storage (e.g., a memory device).

In some example embodiments, at step 208, the computing device 102 may determine bulk velocity (V_{b}) of the multiphase fluid through the section S2 from the average speed of sound (Cavg) along the section S2. At step 210, using the bulk velocity (V_{b}) for the section S2 and the geometry (i.e., the cross-sectional area A) of the production tubing 106 at the section S2, the computing device 102 may determine the bulk volumetric flow rate (Q_{b}) through the section S2. For example, the computing device 102 may use Equation 1 above to calculate the bulk volumetric flow rate (Q_{b}) through the section S2.

At step 212, using the pressure at the wellhead 108 (Pwh), which is known, and an estimated value of the pressure at the location L2 (PL2), the computing device 102 may calculate the average pressure (Pavg) for the section S2. At step 214, using the average temperature (Tavg) for the section S2 and the characterization of the multiphase fluid flowing through the wellbore 104, the computing device 102 may determine liquid phase density for the oil component (ρo) of the multiphase fluid and for the water component (ρw) of the multiphase fluid as can be readily understood by those of ordinary skill in the art. At step 216, using the average temperature (Tavg) and the average pressure (Pavg) for the section S2 as well as the characterization of the multiphase fluid flowing through the wellbore 104, the computing device 102 may determine gas phase density (ρg) for the gas component of the multiphase fluid as can be readily understood by those of ordinary skill in the art.

In some example embodiments, at step 218, the computing device 102 may calculate the bulk density (ρb) in the section S2 using Equation 2 provided above in the same manner described with respect to the section S1. At step 220, the computing device 102 may calculate bulk isentropic compressibility (kb) of the fluid with respect to the section S2 using Equation 4 provided above. At step 222, using the average temperature (Tavg) for the section S2 and the characterization of the multiphase fluid flowing through the wellbore 104, the computing device 102 may determine liquid phase speed of sound for oil (Co) and liquid phase speed of sound for water (Cw) through the section S2 as can be readily understood by those of ordinary skill in the art. At step 224, using the average temperature (Tavg) and the average pressure (Pavg) for the section S2, as well as the characterization of the multiphase fluid flowing through the wellbore 104, the computing device 102 may determine the gas phase speed of sound (Cg) through the section S2 as can be readily understood by those of ordinary skill in the art.

In some example embodiments, at step 226, the computing device 102 may calculate isentropic compressibility for gas (k_{g}), oil (kₒ), and water (k_{w}) phases using Equations 5a, 5b, and 5c, respectively. At step 228, the computing device 102 may determine volumetric phase fraction for gas (φ_{g}), for oil (φₒ), and for water (φ_{w}) in the section S2 using Equations 6 and 7. At step 230, the computing device 102 may determine volumetric phase flow rates for gas (Q_{g}), for oil (Qₒ), and for water (Q_{w}) through the section S2 based on the bulk volumetric flow rate (Q_{b}) calculated at step 210 using Equation 1 and the volumetric phase fractions (φ_{g}), (φₒ), and (φ_{w}) determined using Equations 6 and 7 at step 228. To illustrate, Equations 8a, 8b, 8c above can be used to calculate the gas volumetric phase flow rate (Q_{g}), the oil volumetric phase flow rate (Qₒ), and the water volumetric phase flow rate (Q_{w}) through the section S2.

In some example embodiments, at step 232, the computing device 102 may convert the volumetric phase flow rates (Q_{g}), (Qₒ), and (Q_{w}) through the section S2 to phase mass flow rates M_{g}, Mₒ, M_{w} through the section S2 using Equations 9a, 9b, and 9c above, respectively. At step 234, the computing device 102 may determine calculated total mass flow rate (Mtotcalc) for the section S2 by summing the phase mass flow rates M_{g}, Mₒ, M_{w} through the section S2 determined using Equations 9a, 9b, and 9c, respectively. At step 236, the computing device 102 may determine a total mass flow rate difference (Mtoterr) between the known total mass flow rate (Mtotwh) and the calculated total mass flow rate (Mtotcalc). At step 238, the computing device 102 may determine whether the total mass flow rate difference (Mtoterr) calculated for the section S2 is within a threshold value (e.g., 5%) of the known total mass flow rate (Mtotwh).

In some example embodiments, if the total mass flow rate difference (Mtoterr) is outside of the threshold, the computing device 102 may change the estimated pressure at the location L2 (PL2) up or down depending on the sign of the total mass flow rate difference (Mtoterr) as can be readily understood by those of ordinary skill in the art. After the estimated pressure at the location L2 (PL2) is updated, the computing device 102 may repeat (i.e., iterate through) steps 202-238 of the method 200 for the section S2 until the total mass flow rate difference (Mtoterr) is within a threshold value. If the total mass flow rate difference (Mtoterr) is within a threshold value (e.g., 5%) of the known total mass flow rate (Mtotwh) following the execution of the steps 202-238, the computing device 102 may designate the estimated pressure at the location L2 (PL2) used in the particular execution of the steps 202-238 as the final estimated pressure at the location L2 (PL2). The final estimated pressure at the location L2 (PL2) may be used as a known pressure with respect to the section S5.

In some example embodiments, the computing device 102 may execute the steps 202-234 of the method 200 with respect to the section S3 in parallel with the steps 202-238 of the method 200 with respect to the section S2. For example, for each iteration of the steps 202-238 with respect to the section S2, the computing device 102 may in parallel execute steps 202-234 with respect to the section S3. The computing device 102 may execute the steps 202-234 with respect to the section S3 based on the pressure at the location L2 (PL2) that is used in the execution of the steps 202-238 with respect to the section S2. The location L2 is considered an estimated-pressure location with respect to the section S3. The computing device 102 may also use the final estimated BHP determined with respect to the section S1 as a known pressure during the execution of the steps 202-234 with respect to the section S3.

To illustrate, the computing device 102 may use, at step 202, the final estimated BHP determined with respect to the section S1 (or the BHP measured by the pressure sensor 118) and the same estimated value of the pressure at the location L2 (PL2) used with respect to the section S2 to calculate the pressure difference (ΔP) across the section S3, i.e., calculate BHP−PL2. At step 204, the computing device 102 may obtain the average temperature (Tavg) along the section S3 of the wellbore 104. For example, the computing device 102 may determine the average temperature (Tavg) or obtain, directly or indirectly, the average temperature (Tavg) from the DTS of the distributed sensing system 110. To illustrate, the computing device 102 may obtain the average temperature (Tavg) from data storage (e.g., a memory device). For example, the average temperature (Tavg) may have been determined by the computing device 102 based on sensor data from the distributed sensing system 110 and stored in the memory device of the computing device 102.

In some example embodiments, at step 206, the computing device 102 may obtain the average speed of sound (Cavg) along the section S3. For example, the computing device 102 may obtain the average speed of sound (Cavg) from the DAS of the distributed sensing system 110. Alternatively, the computing device 102 may obtain the average speed of sound (Cavg) from data storage (e.g., a memory device). For example, the average speed of sound (Cavg) may have been determined by the computing device 102 based on sensor data from the distributed sensing system 110 and stored in the memory device of the computing device 102.

In some example embodiments, at step 208, the computing device 102 may determine bulk velocity (V_{b}) of the multiphase fluid through the section S3 from the average speed of sound (Cavg) along the section S3. At step 210, using the bulk velocity (V_{b}) for the section S3 and the geometry (i.e., the cross-sectional area A) of the production tubing 106 at the section S3, the computing device 102 may determine the bulk volumetric flow rate (Q_{b}) through the section S3. For example, the computing device 102 may use Equation 1 above to calculate the bulk volumetric flow rate (Q_{b}) through the section S3.

At step 212, the computing device 102 may also use the final estimated BHP determined with respect to the section S1 (or the BHP measured by the pressure sensor 118) and the same estimated value for the pressure at the location L2 (PL2) used with respect to the section S2 to calculate the average pressure (Pavg) for the section S3. At step 214, using the average temperature (Tavg) for the section S3 and the characterization of the multiphase fluid flowing through the wellbore 104, the computing device 102 may determine liquid phase density for the oil component (ρo) of the multiphase fluid and for the water component (ρw) of the multiphase fluid as can be readily understood by those of ordinary skill in the art. At step 216, using the average temperature (Tavg) and the average pressure (Pavg) for the section S3 as well as the characterization of the multiphase fluid flowing through the wellbore 104, the computing device 102 may determine gas phase density (ρg) for the gas component of the multiphase fluid as can be readily understood by those of ordinary skill in the art.

In some example embodiments, at step 218, the computing device 102 may calculate the bulk density (ρb) in the section S3 using Equation 2 provided above in the same manner described with respect to the section S1. At step 220, the computing device 102 may calculate bulk isentropic compressibility (kb) of the fluid with respect to the section S3 using Equation 4 provided above. At step 222, using the average temperature (Tavg) for the section S3 and the characterization of the multiphase fluid flowing through the wellbore 104, the computing device 102 may determine liquid phase speed of sound for oil (Co) and liquid phase speed of sound for water (Cw) through the section S3 as can be readily understood by those of ordinary skill in the art. At step 224, using the average temperature (Tavg) and the average pressure (Pavg) for the section S3, as well as the characterization of the multiphase fluid flowing through the wellbore 104, the computing device 102 may determine the gas phase speed of sound (Cg) through the section S3 as can be readily understood by those of ordinary skill in the art.

In some example embodiments, at step 226, the computing device 102 may calculate isentropic compressibility for gas (k_{g}), oil (kₒ), and water (k_{w}) phases using Equations 5a, 5b, and 5c, respectively. At step 228, the computing device 102 may determine volumetric phase fraction for gas (φ_{g}), for oil (φₒ), and for water (φ_{w}) in the section S3 using Equations 6 and 7. At step 230, the computing device 102 may determine volumetric phase flow rates for gas (Q_{g}), for oil (Qₒ), and for water (Q_{w}) through the section S3 based on the bulk volumetric flow rate (Q_{b}) calculated at step 210 using Equation 1 and the volumetric phase fractions (φ_{g}), (φₒ), and (φ_{w}) determined using Equations 6 and 7 at step 228. To illustrate, Equations 8a, 8b, 8c above can be used to calculate the gas volumetric phase flow rate (Q_{g}), the oil volumetric phase flow rate (Qₒ), and the water volumetric phase flow rate (Q_{w}) through the section S3.

In some example embodiments, at step 232, the computing device 102 may convert the volumetric phase flow rates (Q_{g}), (Qₒ), and (Q_{w}) through the section S3 to phase mass flow rates M_{g}, Mₒ, M_{w} through the section S3 using Equations 9a, 9b, and 9c above, respectively. The calculated phase mass flow rates M_{g}, Mₒ, M_{w} through the section S3 that correspond to the final estimated pressure at the location L2 (PL2) determined during the parallel execution of the method 200 with respect to the section S2 are considered as the final calculated phase mass flow rates M_{g}, Mₒ, M_{w} through the section S3. At step 234, the computing device 102 may determine calculated total mass flow rate (Mtotcalc) for the section S3 by summing the phase mass flow rates M_{g}, Mₒ, M_{w} through the section S3 determined at step 232 using Equations 9a, 9b, and 9c, respectively. Because the zone Z1 is the only producing zone in the section S3, the total mass flow rate and phase mass flow rates calculated with respect to the section S3 are the zonal inflow of the zone Z1. In some alternative embodiments, instead of executing the steps of the method 200 in parallel with respect to the sections S2 and S3, the computing device 102 may execute the method 200 only once (i.e., not iteratively) to determine the calculated phase mass flow rates M_{g}, Mₒ, M_{w} through the section S3 after first determining, iteratively as needed, the final estimated pressure at the location L2 (PL2) through the execution of the method 200 with respect to the section S2.

In some example embodiments, the computing device 102 may execute steps 202-238 of the method 200 with respect to the section S4, in the manner described with respect to the section S2, to determine a final estimated pressure at the location L3 (PL3) (i.e., the location L3 being an estimated-pressure location with respect to the section S4) and to determine calculated phase mass flow rates M_{g}, Mₒ, M_{w} through the section S4. In contrast to the execution of the method 200 with respect to the section S2, the computing device 102 uses the pressure at the location L3 (PL3) and the known pressure at the wellhead 108 (Pwh) in steps 202 and 212 with respect to the section S4. To illustrate, at step 202 of the method 200, the computing device 102 may calculate the pressure difference (ΔP) across the section S4, i.e., calculate PL3−Pwh. For example, the initial estimate for the pressure at the location L3 (PL3) may be selected based on the known pressure at the wellhead 108 (Pwh) and the final estimated pressure at the location L2 (PL2) determined with respect to the section S2 as described above. Alternatively, the initial estimate for the pressure at the location L3 (PL3) may be selected in a different manner. At step 212, the computing device 102 may calculate the average pressure (Pavg) for the section S4 using the pressure at the wellhead 108 (Pwh), which is known, and an estimated value of the pressure at the location L3 (PL3). For example, for the first iteration through the method 200, the computing device 102 may use the initial estimate for the pressure at the location L3 (PL3), and updated estimates of the pressure at the location L3 (PL3) may be used in subsequent iterations.

At step 238, the computing device 102 may determine whether the total mass flow rate difference (Mtoterr) calculated for the section S4 at step 236 is within a threshold value (e.g., 5%) of the known total mass flow rate (Mtotwh). If the total mass flow rate difference (Mtoterr) is outside of the threshold, the computing device 102 may change the estimated pressure at the location L3 (PL3) up or down depending on the sign of the total mass flow rate difference (Mtoterr) as can be readily understood by those of ordinary skill in the art. After the estimated pressure at the location L3 (PL3) is updated, the computing device 102 may repeat (i.e., iterate through) steps 202-238 of the method 200 for the section S4 until the total mass flow rate difference (Mtoterr) calculated for the section S4 is within a threshold value. If the total mass flow rate difference (Mtoterr) is within a threshold value (e.g., 5%) of the known total mass flow rate (Mtotwh) following the execution of the steps 202-238, the computing device 102 may designate the estimated pressure at the location L3 (PL3) used in the particular execution of the steps 202-238 as the final estimated pressure at the location L3 (PL3). The final estimated pressure at the location L3 (PL3) may be used as a known pressure with respect to the section S7.

In some example embodiments, the computing device 102 may execute the steps 202-234 of the method 200 with respect to the section S5 in parallel with the steps 202-238 of the method 200 with respect to the section S4. For example, for each iteration of the steps 202-238 with respect to the section S4, the computing device 102 may in parallel execute steps 202-234 with respect to the section S5. The computing device 102 may execute the steps 202-234 with respect to the section S5 based on the pressure at the location L3 (PL3) that is used in the execution of the steps 202-238 with respect to the section S4. The location L3 is considered an estimated-pressure location with respect to the section S5. The computing device 102 may also use the final estimated pressure at the location L2 (PL2) determined with respect to the section S2 as a known pressure during the execution of the steps 202-234 with respect to the section S5.

To illustrate, at step 202, the computing device 102 may use the final estimated pressure at the location L2 (PL2) determined with respect to the section S2 (as known pressure) and the same estimated value of the pressure at the location L3 (PL3) used with respect to the section S4 to calculate the pressure difference (ΔP) across the section S5, i.e., calculate PL2−PL3, for each iteration of the method 200 with respect to the section S5. At step 212, the computing device 102 may also use the final estimated pressure at the location L2 (PL2) determined with respect to the section S2 and the same estimated value of the pressure at the location L3 (PL3) used with respect to the section S4 to calculate the average pressure (Pavg) for the section S5 for each iteration of the method 200 with respect to the section S5.

At step 232, the computing device 102 may convert the volumetric phase flow rates (Q_{g}), (Qₒ), and (Q_{w}) through the section S5 to phase mass flow rates M_{g}, Mₒ, M_{w} through the section S5 using Equations 9a, 9b, and 9c above, respectively. The calculated phase mass flow rates M_{g}, Mₒ, M_{w} through the section S5 that correspond to the final estimated pressure at the location L3 (PL3) determined during the parallel execution of the method 200 with respect to the section S4 are considered as the final calculated phase mass flow rates M_{g}, Mₒ, M_{w} through the section S5. In some alternative embodiments, instead of executing the steps of the method 200 in parallel with respect to the sections S4 and S5, the computing device 102 may execute the method 200 only once (i.e., not iteratively) to determine the calculated phase mass flow rates M_{g}, Mₒ, M_{w} through the section S5 after first determining, iteratively as needed, the final estimated pressure at the location L3 (PL3) through the execution of the method 200 with respect to the section S4.

Because the section S5 includes a single producing zone, the zone Z2, that is adjacent to and above the zone Z1, which is in the section S3, the calculated phase mass flow rates M_{g}, Mₒ, M_{w} through the section S3 may be used to calculate zonal inflow of the zone Z2. To illustrate, at step 234 of the method 200, the computing device 102 may sum the calculated phase mass flow rates M_{g}, Mₒ, M_{w} with respect to the section S5 to calculate the total mass flow rate through the section S5. To determine the zonal inflow of the zone Z2, the computing device 102 may subtract the total mass flow for section S3 from the total mass flow for the section S5. To determine the zonal inflow for each phase, the total mass flow rate from the section S3 must be flashed at the average conditions (pressure and temperature) of section S5 to determine phase mass flow rates transferred from section S3 to section S5. These phase mass flow rates can then be subtracted from the section S5 phase mass flow rates to determine zonal inflows by phase. For example, to determine fluid flash/shrink, the computing device 102 may use a PBM (Phase Behavior Model) or EoS (Equation of State) as can be readily understood by those of ordinary skill in the art.

In some example embodiments, the computing device 102 may execute steps 202-238 of the method 200 with respect to the section S6, in the manner described with respect to the section S2, to determine a final estimated pressure at the location L4 (PL4) (i.e., the location L4 being an estimated-pressure location with respect to the section S6) and to determine calculated phase mass flow rates M_{g}, Mₒ, M_{w} through the section S6. In contrast to the execution of the method 200 with respect to the section S2, the computing device 102 uses the pressure at the location L4 (PL4) and the known pressure at the wellhead 108 (Pwh) with respect to the section S6 in steps 202 and 212. To illustrate, at step 202 of the method 200, the computing device 102 may calculate the pressure difference (ΔP) across the section S6, i.e., calculate PL4−Pwh. For example, the initial estimate for the pressure at the location L4 (PL4) may be selected based on the known pressure at the wellhead 108 (Pwh) and the final estimated pressure at the location L3 (PL3) determined with respect to the section S4 as described above. Alternatively, the initial estimate for the pressure at the location L4 (PL4) may be selected in a different manner. At step 212, the computing device 102 may calculate the average pressure (Pavg) for the section S6 using the pressure at the wellhead 108 (Pwh), which is known, and an estimated value of the pressure at the location L4 (PL4). For example, for the first iteration through the method 200, the computing device 102 may use the initial estimate for the pressure at the location L4 (PL4), and updated estimates of the pressure at the location L4 (PL4) may be used in subsequent iterations.

At step 238, the computing device 102 may determine whether the total mass flow rate difference (Mtoterr) calculated for the section S6 at step 236 is within a threshold value (e.g., 5%) of the known total mass flow rate (Mtotwh). If the total mass flow rate difference (Mtoterr) is outside of the threshold, the computing device 102 may change the estimated pressure at the location L4 (PL4) up or down depending on the sign of the total mass flow rate difference (Mtoterr) as can be readily understood by those of ordinary skill in the art. After the estimated pressure at the location L4 (PL4) is updated, the computing device 102 may repeat (i.e., iterate through) steps 202-238 of the method 200 for the section S6 until the total mass flow rate difference (Mtoterr) calculated for the section S6 is within a threshold value. If the total mass flow rate difference (Mtoterr) is within a threshold value (e.g., 5%) of the known total mass flow rate (Mtotwh) following the execution of the steps 202-238, the computing device 102 may designate the estimated pressure at the location L4 (PL4) used in the particular execution of the steps 202-238 as the final estimated pressure at the location L4 (PL4).

In some example embodiments, the computing device 102 may execute the steps 202-234 of the method 200 with respect to the section S7 in parallel with the steps 202-238 of the method 200 with respect to the section S6. For example, for each iteration of the steps 202-238 with respect to the section S6, the computing device 102 may in parallel execute steps 202-234 with respect to the section S7. The computing device 102 may execute the steps 202-234 with respect to the section S7 based on the pressure at the location L4 (PL4) that is used in the execution of the steps 202-238 with respect to the section S6 and a known pressure at the location L3. The location L4 is considered an estimated-pressure location with respect to the section S7 whereas the final estimated pressure at the location L3 (PL3) determined with respect to the section S4 is a known pressure during the execution of the steps 202-234 with respect to the section S7.

To illustrate, at step 202, the computing device 102 may use the final estimated pressure at the location L3 (PL3) determined with respect to the section S4 and the same estimated value of the pressure at the location L4 (PL4) used with respect to the section S6 to calculate the pressure difference (ΔP) across the section S7, i.e., calculate PL3−PL4, for each iteration of the method 200 with respect to the section S7. At step 212, the computing device 102 may also use the final estimated pressure at the location L3 (PL3) determined with respect to the section S4 and the same estimated value of the pressure at the location L4 (PL4) used with respect to the section S6 to calculate the average pressure (Pavg) for the section S7 for each iteration of the method 200 with respect to the section S7.

At step 232, the computing device 102 may convert the volumetric phase flow rates (Q_{g}), (Qₒ), and (Q_{w}) through the section S7 to phase mass flow rates M_{g}, Mₒ, M_{w} through the section S7 using Equations 9a, 9b, and 9c above, respectively. The calculated phase mass flow rates M_{g}, Mₒ, M_{w} through the section S7 that correspond to the final estimated pressure at the location L4 (PL4) determined during the parallel execution of the method 200 with respect to the section S6 are considered as the final calculated phase mass flow rates M_{g}, Mₒ, M_{w} through the section S7. In some alternative embodiments, instead of executing the steps of the method 200 in parallel with respect to the sections S6 and S7, the computing device 102 may execute the method 200 only once (i.e., not iteratively) to determine the calculated phase mass flow rates M_{g}, Mₒ, M_{w} through the section S7 after first determining, iteratively as needed, the final estimated pressure at the location L4 (PL4) through the execution of the method 200 with respect to the section S6.

Because the section S7 includes a single producing zone, the zone Z3, that is adjacent to and above the zone Z2, which is in the section S5, the calculated phase mass flow rates M_{g}, Mₒ, M_{w} through the section S5 (i.e., calculated at step 232 of the method 200 with respect to the section S5) may be used to calculate zonal inflow of the zone Z3. To illustrate, at step 234 of the method 200, the computing device 102 may sum the calculated phase mass flow rates M_{g}, Mₒ, M_{w} with respect to the section S7 to calculate the total mass flow rate through the section S7. The computing device 102 may determine the zonal inflow of the zone Z3 by performing mass balance involving subtracting total mass flow rate through the section S5 from the calculated total mass flow rate through the section S7. To determine the zonal inflow for each phase, the total mass flow rate from the section S5 must be flashed at the average conditions (pressure and temperature) of section S7 to determine phase mass flow rates transferred from section S5 to section S7. These phase mass flow rates can then be subtracted from the section S7 phase mass flow rates to determine zonal inflows by phase for zone Z3. For example, to determine fluid flash/shrink, the computing device 102 may use a PBM (Phase Behavior Model) or EoS (Equation of State) as can be readily understood by those of ordinary skill in the art.

Because the section S6 includes a single producing zone, the zone Z4, that is adjacent to and above the zone Z3, which is in the section S7, the calculated phase mass flow rates M_{g}, Mₒ, M_{w} through the section S7 may be used to calculate zonal inflow of the zone Z4. To illustrate, the computing device 102 may determine the zonal inflow of the zone Z4 by subtracting the total mass flow rate through the section S7 from the calculated total mass flow rate through the section S6. To determine the zonal inflow for each phase, the total mass flow rate from the section S7 must be flashed at the average conditions (pressure and temperature) of section S6 to determine phase mass flow rates transferred from section S7 to section S6. These phase mass flow rates can then be subtracted from the section S6 phase mass flow rates to determine zonal inflows by phase for zone Z4. For example, to determine fluid flash/shrink, the computing device 102 may use a PBM (Phase Behavior Model) or EoS (Equation of State) as can be readily understood by those of ordinary skill in the art. T

By executing the method 200 as described above with respect to the sections S1, S2, S3, S4, S5, S6, S7, the pressure at the locations L1, L2, L3, L4 can be determined/estimated. By executing the method 200 as described above with respect to the sections S1, S2, S3, S4, S5, S6, S7, phase mass flow rates and total mass flow rates through the producing zones Z1, Z2, Z3, Z4 and zonal inflows of each one of the producing zones Z1, Z2, Z3, Z4 can be determined/estimated. The pressure, mass flow rates, and zonal inflows determined using the system 100 and the method 200 provide information that enables improved management of the wellbore 104. The information may also be valuable in the management of other wellbores such as nearby wellbores that may be similar to the wellbore 104. Note that this is an example embodiment only, and the wellbore 104 may be divided into sections other than those shown and different pressures may be estimated. In addition, while a sequential example has been given for clarity, it is also possible that multiple pressures may be estimated simultaneously without departing from the scope of this disclosure.

In some alternative embodiments, a one-to-one producing zone to section association may not be possible for every producing zone of the wellbore 104. For example, a limitation imposed by the resolution of the DAS of the distributed sensing system 110 may restrict the number of sections that have a single zone. In such cases, a zone may not be included in a section as the only zone. To illustrate with respect to the zones Z3 and Z4, in some alternative embodiments, the sections S6 and S7 may be omitted (i.e., the method 200 may not be executed with respect to the sections S6 and S7), because of the limited resolution of the DAS of the distributed sensing system 110. In such a case, the phase mass flow rates and total mass flow rate determined with respect to the section S4 are applicable to both zones Z3 and Z4. Also, “zonal” inflow for each phase that may be determined with respect to the section S4 by determining flash/shrink from the section S5 to the section S4 and by performing mass balance on the section S4 applies to both zones Z3 and Z4.

In some example embodiments, the method 200 may be performed with respect to one or more other sections instead of or in addition to some of the sections S1, S2, S3, S4, S5, S6, S7. For example, a new section may be defined/bound by the locations L1 and L3 (i.e., includes the zones Z1 and Z2 but not the zones Z3 and Z4), and the method 200 may be performed with respect to the particular section. As another example, a new section may be defined/bound by the locations L1 and L4 (i.e., includes the zones Z1, Z2, and Z3 but not the zone Z4), and the method 200 may be performed with respect to the particular section. In these examples, while the method 200 can be applied to these sections as defined, it may also be simultaneously applied to the section above the defined section, in order to estimate a total mass flow on which to base the iteration of pressure. In some alternative embodiments, some of the sections S1, S2, S3, S4, S5, S6, S7 may be omitted without departing from the scope of this disclosure. For example, if information about a particular producing zone is not needed or already known, a section that includes the particular zone only may be omitted. In some example embodiments, the method 200 may be performed in parallel with respect to multiple sections of the sections S1, S2, S3, S4, S5, S6, S7 without departing from the scope of this disclosure. In some alternative embodiments, the locations L1, L2, L3, L4 may be different locations than shown in FIGS. 1 and 3 without departing from the scope of this disclosure.

In some example embodiments, the method 200 may be performed in parallel (i.e., simultaneously) with respect to multiple sections of the sections S1, S2, S3, S4, S5, S6, S7 without departing from the scope of this disclosure. For example, the computing device 102 may execute the method 200 with respect to the sections S1, S2, S4, S6 by simultaneously iterating through the method 200 with respect to each section by changing the estimated pressure at the locations L1, L2, L3, L4. The computing device 102 may execute the method 200 simultaneously with respect to the sections S1, S2, S4, S6 based on the respective total mass flow rate difference (Mtoterr) calculated at step 236 and the comparison against the known total mass flow rate at the wellhead 108 (Mtotwh) performed at step 238. In some example embodiments, simultaneous executions of the method 200 with respect to multiple sections may result in multiple feasible sets of pressure at the locations L1, L2, L3, L4, flow rates through the sections, and zonal inflows, from which a most probable set may be selected, for example, based on the experience of an operator.

In some alternative embodiments, the system 100 may include one or more downhole pressures sensors in addition to the pressure sensor 114 without departing from the scope of this disclosure. In some alternative embodiments, the system 100 may include one or more downhole flow meters in addition to the flow meter 116 without departing from the scope of this disclosure. In some alternative embodiments, one or more components of the system 100 may be omitted without departing from the scope of this disclosure.

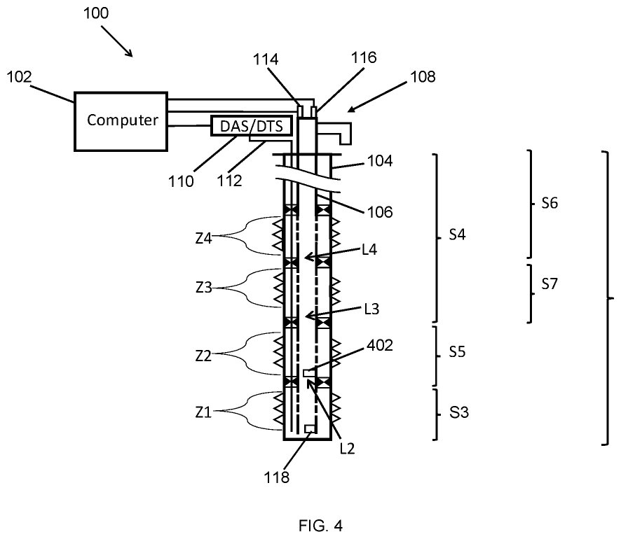

FIG. 4 illustrates the system 100 and multiple sections of the wellbore according to another example embodiment. Referring to FIGS. 1, 2A, 2B, and 4, in some example embodiments, the system 100 includes the computing device 102, the distributed sensing system 110, the pressure sensor 114, the flow meter 116 (or another means of determining flow), and the pressure sensor 118. The system 100 may also include a pressure sensor 402 that is at the location L2. Because the pressure at the location L2 is known (i.e., the pressure sensor 402 provides reliable pressure information at the location L2), the section S2 shown in FIG. 3 may be omitted. That is, in embodiments of the system 100 that include the pressure sensor 402, the method 200 may not be executed with respect to the section S2 shown in FIG. 3 unless the information from the pressure sensor 402 is unreliable. The system 100 of FIG. 4 may be used to determine/estimate the pressure at the locations L3, L4. The system 100 of FIG. 4 may also be used to determine/estimate phase and total mass flow rate through the sections S1-S7, and to determine/estimate zonal inflows of the zones Z1, Z2, Z3, Z4.

Referring to FIG. 4, in general, the computing device 102 may execute the steps 202-234 of the method 200 with respect to the section S5 in the manner described above with respect to FIG. 3 with the exception of the use of pressure information from the pressure sensor 402. To illustrate, the computing device 102 may execute the method 200 with respect to the section S5 using the pressure information from the pressure sensor 402 at the location L2 and the final estimated pressure at the location L3 (PL3) determined with respect to section S4. For example, with respect to step 202 of the method 200, the computing device 102 may calculate the pressure difference (ΔP) across the section S5 using the pressure measured by the pressure sensor 402 as the known pressure. The computing device 102 may also use the pressure measured by the pressure sensor 402 in executing step 212 of the method 200. With respect to the sections S1, S4, S6, and S7, the computing device 102 may perform the method 200 in the same manner as described with respect to FIG. 3. In some alternative embodiments, the section S1 may be omitted if the pressure information from the pressure sensor 118 is reliable.

In some example embodiments, phase mass flow rates may be determined through the section S3 based on the BHP and the known pressure at the location L2 by executing the steps 202-234. The BHP is measured by the pressure sensor 118 or determined with respect to the section S1 as described with respect to FIG. 1, and the known pressure at the location L2 is measured by the pressure sensor 402 as shown in FIG. 4. In contrast to the execution of the method 200 with respect to the section S3 in FIG. 1, the steps 202 and 212 of the method 200 are performed with respect to FIG. 4 based on two known pressures—the BHP and the pressure at the locations L2.

In some example embodiments, the zonal inflows of the zones Z1, Z2, Z3, Z4 may be determined in the same manner as described with respect to FIG. 3. For example, because the zone Z1 is the only producing zone in the section S3, the total mass flow rate calculated with respect to section S3 is the zonal inflow of the zone Z1. The computing device 102 may use the phase mass flow rates through the section S3 to perform mass balance to determine the zonal inflow of the zone Z2 in section S5. The computing device 102 may use the phase mass flow rates through the section S5 to perform mass balance to determine the zonal inflow of the zone Z3 in section S7. The computing device 102 may use the phase mass flow rates through the section S7 to perform mass balance to determine the zonal inflow of the zone Z4 in section S6.

In some alternative embodiments, the computing device 102 may execute the method 200 with respect to some of the sections of the wellbore 104 in parallel. In some alternative embodiments, the system 100 shown in FIG. 4 may include one or more other pressure sensors than shown without departing from the scope of this disclosure. In some alternative embodiments, the pressure sensor 402 may be at a different location than shown without departing from the scope of this disclosure. In some alternative embodiments, the pressure sensor 118 shown in FIG. 4 may be omitted without departing from the scope of this disclosure. In some alternative embodiments, the system 100 shown in FIG. 4 may include one or more flow meters in addition to the flow meter 116. In some alternative embodiments, one or more components of the system 100 shown in FIG. 4 may be omitted without departing from the scope of this disclosure.

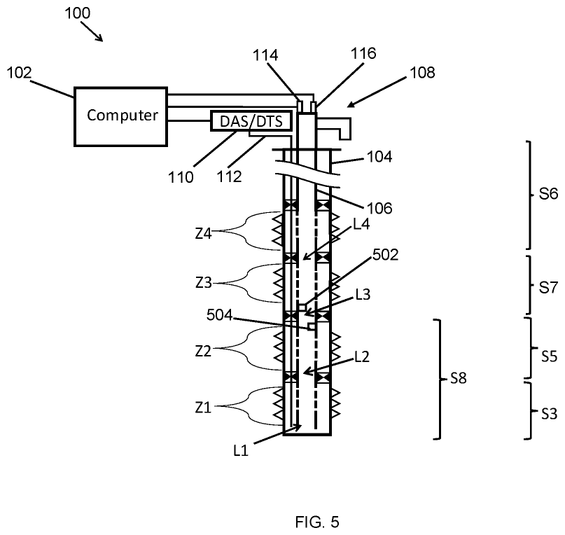

FIG. 5 illustrates the system of FIG. 1 and multiple sections of the wellbore according to another example embodiment. Referring to FIGS. 1, 2A, 2B, and 5, in some example embodiments, the system 100 includes the computing device 102, the distributed sensing system 110, the pressure sensor 114, and the flow meter 116 (or another means of determining flow). The system 100 may also include a pressure sensor 502 that is at the location L3 and a flow meter 504 positioned to measure phase mass flow rate and/or total mass flow rate through the section S8 resulting from inflows of zones Z1 and Z2. The system 100 of FIG. 5 may be used to determine/estimate the pressure at the locations L1, L2, L4, to determine/estimate phase and total mass flow rate through the sections S3, S5, S6, and S7, and to determine/estimate zonal inflows of the zones Z1, Z2, Z3, Z4.

In some example embodiments, the computing device 102 may execute the method 200 with respect to the sections S3, S5, S6, S7, S8 shown in FIG. 5 based on the pressure measurements by the pressure sensors 114 and 502 and based on the flow rate measurement by the flow meters 116 and 504 in a similar manner as described above with respect to FIG. 3. To illustrate, the computing device 102 may use the known pressure as measured by the pressure sensor 502 and the known total mass flow rate as measured by the flow meter 504 to determine/estimate the pressure at the location L1 (BHP) with respect to the section S8 in a similar manner as described above, for example, with respect to the section S1. For example, with respect to the section S8, the computing device 102 may use the pressure measured by the pressure sensor 502 as the known pressure with respect to step 202 of the method 200 and may iterate through the method 200, as needed, by changing the estimated BHP until the calculated total mass flow rate at step 236 of the method 200 is within a threshold value (e.g., 5%) of the total mass flow rate as measured by the flow meter 504 as determined at step 238 of the method 200.

In some example embodiments, after determining BHP with respect to the section S8, the computing device 102 may execute the method 200 with respect to the section S5 to determine the pressure at the location L2 (PL2) and to calculate the phase mass flow rates through the section S5. For example, the computing device 102 may execute the method 200 with respect to the section S5 in a similar manner as described, for example, with respect to the section S6 of FIG. 3, where the total mass flow rate at the wellhead 108 (Mtotwh) is known through measurement by the flow meter 116. To illustrate, with respect to the section S5, the computing device 102 may use the pressure measured by the pressure sensor 502 as a known pressure at step 202 and iteratively change, as needed, the pressure at the location L2 (PL2) until the calculated total mass flow rate at step 236 is within a threshold value (e.g., 5%) of the total mass flow rate as measured by the flow meter 504.

In some example embodiments, with respect to the section S3, the computing device 102 may execute the method 200 in substantially the same manner as described with respect to FIG. 3. For example, the computing device 102 may execute the steps 202-234 of the method 200 with respect to the section S3 in parallel with the section S5. Alternatively, the computing device 102 may execute the steps 202-234 of the method 200 with respect to the section S3 after determining the final estimated pressure at the location L2 (PL2) with respect to the section S5.

In some example embodiments, the computing device 102 may execute the method 200 with respect to the sections S6 and S7 in substantially the same manner as described with respect to FIG. 3 to determine a final estimate of the pressure at the location L4 (PL4) and to calculate the phase and total mass flow rates through the sections S6 and S7. With respect to the section S7, the computing device 102 may use the pressure measured by the pressure sensor 502 as the known pressure at the location L3 in executing steps 202 and 212 of the method 200.

In some example embodiments, the phase mass flows calculated with respect to the section S3 can be summed to determine the zonal inflow for the zone Z1. The computing device 102 may perform mass balance to determine the zonal inflows of the zones Z2, Z3, Z4 in substantially the same manner as described above with respect to FIG. 3.

In some alternative embodiments, the computing device 102 may execute the method 200 with respect to some of the sections S3, S5, S6, S7, S8 in parallel. In some alternative embodiments, the system 100 shown in FIG. 5 may include one or more other pressure sensors and flow meters than shown without departing from the scope of this disclosure. In some alternative embodiments, the pressure sensor 502 and the flow meter 504 may be at different locations than shown without departing from the scope of this disclosure. In some alternative embodiments, one or more components of the system 100 shown in FIG. 5 may be omitted without departing from the scope of this disclosure.

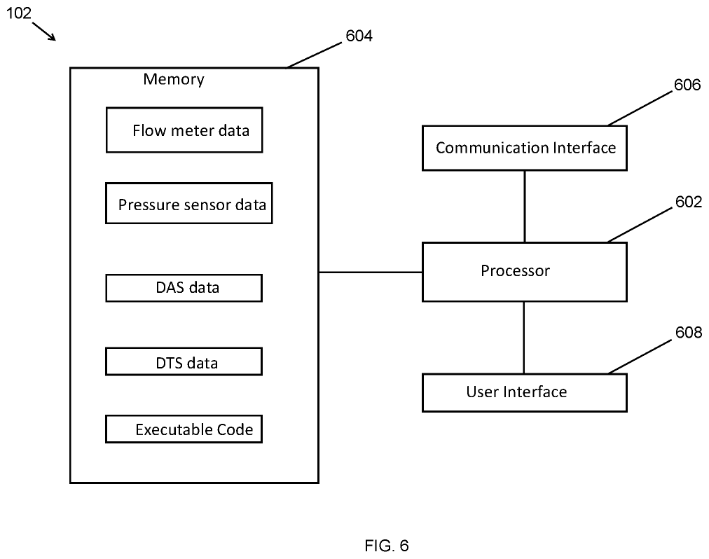

FIG. 6 illustrates a block diagram of the computing device 102 of FIG. 1 according to an example embodiment. Referring to FIGS. 1-6, in some example embodiments, the computing device 102 may include a processor 602 (e.g., one or more microprocessors) and a memory device 604. The computing device 102 may also include a communication interface 606 that enables the computing device 102 to communicate wirelessly or via wired connections. The computing device 102 may also include a user interface 608 that enables the computing device 102 to receive user inputs and to provide (e.g., display) information to a user.

In some example embodiments, the memory device 604 may include one or more memory units such as static memory units (e.g., flash memory) and other types of memory units. Information from one or more flow meters (e.g., the flow meter 116 of FIG. 1 and the flow meter 504 of FIG. 5) may be stored in the memory device 604. Information from the one or more pressure sensors (e.g., the pressure sensor 118 and the pressure sensor 502) may be stored in the memory device 604. Information from the DAS and DTS of the distributed sensing system 110 may also be stored in the memory device 604. Executable software code may also be stored in the memory device 604, and the processor 602 may execute the executable software code to perform operations described herein with respect to the computing device 102.

In some example embodiments, the computing device 102 may be a desktop computer, a laptop computer, or another type of computing device. In some example embodiments, the computing device 102 may include components other than shown in FIG. 6 without departing from the scope of this disclosure.

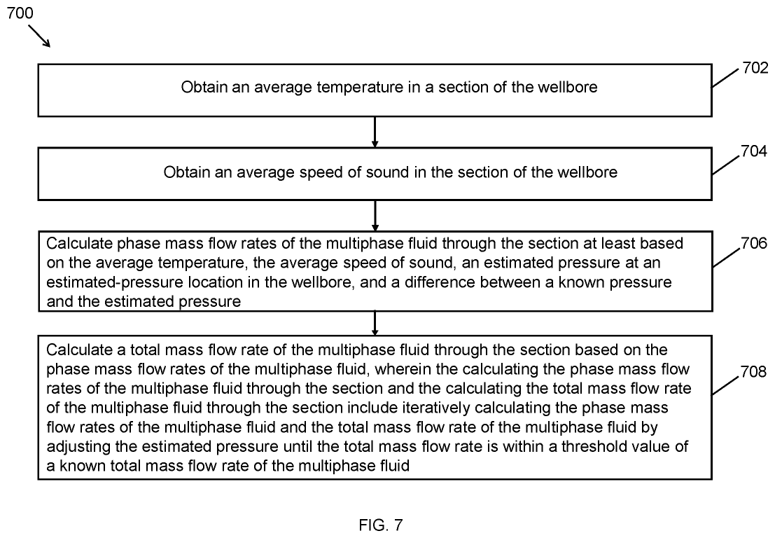

FIG. 7 illustrates a method 700 for estimating pressure and flow rates of a multiphase fluid flowing through the wellbore 104 according to an example embodiment. Referring to FIGS. 1-7, in some example embodiments, at step 702, the method 700 includes obtaining an average temperature in a section of the wellbore 104. For example, the computing device 102 may obtain an average temperature of the fluid in each of the sections S1, S2, S3, S4, S5, S6, S7, S8 of the wellbore 104 from the distributed sensing system 110. Alternatively, the computing device 102 may obtain temperature readings from the distributed sensing system 110 or another source and determine the average temperature for each of the sections S1, S2, S3, S4, S5, S6, S7, S8.

In some example embodiments, at step 704, the method 700 includes obtaining an average speed of sound in the fluid in the section of the wellbore 104. For example, the computing device 102 may obtain an average speed of sound in the fluid with respect to each of the sections S1, S2, S3, S4, S5, S6, S7, S8 from the DAS of the distributed sensing system 110. Alternatively, the computing device 102 may obtain sound readings from the DAS of the distributed sensing system 110 or another source and determine the average speed of sound in the fluid for each of the sections S1, S2, S3, S4, S5, S6, S7, S8.

In some example embodiments, at step 706, the method 700 may include calculating phase mass flow rates of the multiphase fluid through the section at least based on the average temperature, the average speed of sound, an estimated pressure at an estimated-pressure location in the wellbore, and a difference between a known pressure and the estimated pressure. For example, the computing device 102 may calculate phase mass flow rates through each of the sections S1, S2, S3, S4, S5, S6, S7, S8 based, in part, on the average temperature and the average speed of sound for the respective section. The phase mass flow rates calculation for each of the sections S1, S2, S3, S4, S5, S6, S7, S8 is further based on an estimated pressure at the respective estimated-pressure location, such as the locations L1, L2, L3, L4 shown, for example, in FIGS. 1 and 3, as well as known phase behavior of the fluids in the wellbore. The phase mass flow rates calculation is further based on the difference between the known pressure (e.g., pressure measured by the pressure sensor 114) and the estimated pressure calculated, in the manner described above with respect to step 202 of the method 200.

In some example embodiments, at step 708, the method 700 includes calculating a total mass flow rate of the multiphase fluid through the section based on the phase mass flow rates of the multiphase fluid. For example, the computing device 102 may calculate the total mass flow rate through each of the sections S1, S2, S3, S4, S5, S6, S7, S8 by summing the phase mass flow rates through the respective section in the manner described with respect to the step 234 of the method 200. The phase mass flow rates of the multiphase fluid through the section and the total mass flow rate of the multiphase fluid through the section (e.g., each of the sections S1, S2, S4, S6 shown in FIGS. 1 and 3 and each of the sections S5, S8 shown in FIG. 5) are calculated by iteratively adjusting the estimated pressure (e.g., the pressure at the location L1, L2, L3, L4) until the total mass flow rate is within a threshold value of a known total mass flow rate (e.g., the known flow rate at the wellhead 108 (Mtotwh) or the known flow rate at the location L3 as shown in FIG. 5) of the multiphase fluid.

In some example embodiments, the method 700 may also include calculating (e.g., by the computing device 102) phase mass flow rates of the multiphase fluid through a second section (e.g., each of the sections S3, S5, S7 as shown in FIG. 3) of the wellbore 104 at least based on an average temperature in the second section, an average speed of sound in the second section, the estimated pressure, and a difference between a second known pressure at a second known-pressure location (e.g., the locations L1, L2, L3) in the wellbore 104 and the estimated pressure. For example, the computer device 102 may use the difference in the BHP (i.e., known pressure) and the pressure at the location L2 (i.e., estimated pressure) as described with respect to step 202 of the method 200 and the section S3 shown in FIG. 3. As another example, the computer device 102 may use the difference in the final estimated pressure at the location L2 (i.e., known pressure) and the pressure at the location L3 (i.e., estimated pressure) as described with respect to step 202 of the method 200 and the section S5 shown in FIG. 3.

In some example embodiments, the method 700 may also include determining a zonal inflow in the section (e.g., the section S6 shown in FIG. 3) by performing a mass balance calculation based on the phase mass flow rates of the multiphase fluid through the section and the phase mass flow rates of the multiphase fluid through a second section (e.g., the section S7) of the wellbore 104. In some example embodiments, the method 700 may also include determining a zonal inflow in the second section (e.g., the section S7) by performing a mass balance calculation based on the phase mass flow rates of the multiphase fluid through the second section (e.g., the section S7) and phase mass flow rates of the multiphase fluid through a third section (e.g., the section S5) of the wellbore 104, where the third section is below the second section and includes at least one other production zone.

In some example embodiments, the method 700 may also include calculating phase mass flow rates of the multiphase fluid through a second section (e.g., the section S4 in FIG. 3) at least based on an average temperature in the second section, an average speed of sound in the second section, a second estimated pressure at a second estimated-pressure location (e.g., the location L3) in the wellbore 104 that is different from the estimated-pressure location (e.g., the location L2 that may be used at step 706 of the method 700 with respect to another section (e.g., with respect to the section S2)), and a difference between the known pressure (e.g., pressure at the wellhead 108 (Pwh)) and the second estimated pressure. The method 700 may also include calculating a total mass flow rate of the multiphase fluid through the second section (e.g., the section S4) based on the phase mass flow rates of the multiphase fluid through the second section.

The phase mass flow rates of the multiphase fluid through the section and the total mass flow rate of the multiphase fluid through the section (e.g., each of the sections S1, S2, S4, S6 shown in FIGS. 1 and 3 and each of the sections S5, S8 shown in FIG. 5) are calculated by iteratively adjusting the estimated pressure (e.g., the pressure at each of the locations L1, L2, L3, L4) until the total mass flow rate is within a threshold value of a known total mass flow rate (e.g., the known flow rate at the wellhead 108 (Mtotwh) or the known flow rate at the location L3 as shown in FIG. 5) of the multiphase fluid. The phase mass flow rates of the multiphase fluid through the second section (e.g., the section S4) and the total mass flow rate of the multiphase fluid through the second section (e.g., the section S4) are calculated iteratively by adjusting the second estimated pressure (e.g., the pressure at the location L3) until the total mass flow rate through the second section is within a second threshold value of the known total mass flow rate of the multiphase fluid (e.g., the known flow rate at the wellhead 108 (Mtotwh)).

By executing the method 700, the pressure at downhole locations of the wellbore 104, flow rates through the sections S1, S2, S3, S4, S5, S6, S7, S8, and the zonal inflows of the zones Z1, Z2, Z3, Z4 can be reliably estimated. The information obtained regarding the wellbore 104 by performing the method 700 may result in better management of the wellbore 104 and may be useful in managing nearby wellbores. By reliably estimating downhole pressure at various downhole locations, flow rates, and zonal inflows as described herein, the number of downhole pressure sensors and flow meters that may otherwise be required to achieve the same well management goals can be reduced.

In some alternative embodiments, the steps of the method 700 may be performed in a different order than described above without departing from the scope of this disclosure. In some alternative embodiments, the method 700 may include one or more additional steps without departing from the scope of this disclosure. In some alternative embodiments, the one or more of the steps of the method 700 may be omitted without departing from the scope of this disclosure.

Although various embodiments and examples have been provided herein, those of ordinary skill in the art will appreciate that these embodiments and examples are not limiting. For instance, an embodiment or example describing two sections may be extended to more than two sections. The term “acoustic sensor” may include a single acoustic sensor, an array of acoustic sensors, a distributed acoustic sensor (DAS) such as a fiber optic cable, etc. The term “temperature sensor” may include a single temperature sensor, an array of temperature sensors, a distributed temperature sensor (DTS) such as a fiber optic cable, etc.

Although some embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the scope of the following claims, the scope of which are to be accorded the broadest interpretation so as to encompass modifications and equivalent structures.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, and components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Unless defined otherwise, all technical and scientific terms used herein have the same meanings as commonly understood by one of skill in the art to which the disclosed invention belongs. All citations referred herein are expressly incorporated by reference.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer-implemented method of determining wellbore pressures and multiphase fluid flow rates, the method comprising:
obtaining an average temperature of a multiphase fluid in a section of a wellbore;
obtaining an average speed of sound in the multiphase fluid in the section of the wellbore;
calculating phase mass flow rates of the multiphase fluid through the section at least based on the average temperature, the average speed of sound, an estimated pressure at an estimated-pressure location in the wellbore, and a difference between a known pressure and the estimated pressure; and
calculating a total mass flow rate of the multiphase fluid through the section based on the phase mass flow rates of the multiphase fluid, wherein the calculating the phase mass flow rates of the multiphase fluid through the section and the calculating the total mass flow rate of the multiphase fluid through the section comprise iteratively calculating the phase mass flow rates of the multiphase fluid and the total mass flow rate of the multiphase fluid by adjusting the estimated pressure until the total mass flow rate is within a threshold value of a known total mass flow rate of the multiphase fluid.

2. The computer-implemented method of claim 1, further comprising calculating phase mass flow rates of the multiphase fluid through a second section of the wellbore at least based on an average temperature in the second section, an average speed of sound in the second section, the estimated pressure, and a difference between a second known pressure at a second known-pressure location in the wellbore and the estimated pressure, wherein the second section is adjacent to the section and includes at least one producing zone of the wellbore.

3. The computer-implemented method of claim 2, wherein the calculating phase mass flow rates of the multiphase fluid through the second section is performed at each iteration of calculating the phase mass flow rates of the multiphase fluid through the section and the total mass flow rate of the multiphase fluid through the section.

4. The computer-implemented method of claim 2, wherein the second known pressure is a bottom hole pressure of the wellbore.

5. The computer-implemented method of claim 2, wherein the second section is above at least one other producing zone of the wellbore.

6. The computer-implemented method of claim 2, further comprising determining a zonal inflow in the section by performing a mass balance calculation based on the phase mass flow rates of the multiphase fluid through the section and the phase mass flow rates of the multiphase fluid through the second section of the wellbore.

7. The computer-implemented method of claim 6, wherein determining the zonal inflow in the section comprises performing a flash calculation based on the phase mass flow rates of the multiphase fluid through the second section at average conditions in the section.

8. The computer-implemented method of claim 2, further comprising determining a zonal inflow in the second section by performing a mass balance calculation based on the phase mass flow rates of the multiphase fluid through the second section and phase mass flow rates of the multiphase fluid through a third section of the wellbore, wherein the third section is below the second section and includes at least one other producing zone.

9. The computer-implemented method of claim 1, wherein the section of the wellbore is an entirety of the wellbore and the estimated pressure is a bottom hole pressure of the wellbore.

10. The computer-implemented method of claim 1, further comprising calculating phase mass flow rates of the multiphase fluid through a second section at least based on an average temperature in the second section, an average speed of sound in the second section, a second estimated pressure at a second estimated-pressure location in the wellbore that is different from the estimated-pressure location, and a difference between the known pressure and the second estimated pressure; and
calculating a total mass flow rate of the multiphase fluid through the second section based on the phase mass flow rates of the multiphase fluid through the second section, wherein the phase mass flow rates of the multiphase fluid through the second section and the total mass flow rate of the multiphase fluid through the second section are calculated iteratively by adjusting the second estimated pressure until the total mass flow rate through the second section is within a second threshold value of the known total mass flow rate of the multiphase fluid.

11. A system for determining wellbore pressures and multiphase fluid flow rates, the system comprising:
a temperature sensor configured to measure temperature for use in determining an average temperature of a multiphase fluid in a section of a wellbore;
an acoustic sensor configured to measure sound for use in determining an average speed of sound in the multiphase fluid in the section of the wellbore; and
a computing device configured to:
calculate phase mass flow rates of the multiphase fluid through the section at least based on the average temperature, the average speed of sound, an estimated pressure at an estimated-pressure location in the wellbore, and a difference between a known pressure and the estimated pressure; and
calculate a total mass flow rate of the multiphase fluid through the section based on the phase mass flow rates of the multiphase fluid, wherein the computing device is configured to calculate the phase mass flow rates of the multiphase fluid and the total mass flow rate of the multiphase fluid by iteratively calculating the phase mass flow rates of the multiphase fluid and the total mass flow rate of the multiphase fluid by adjusting the estimated pressure until the total mass flow rate is within a threshold value of a known total mass flow rate of the multiphase fluid.

12. The system of claim 11, wherein the computing device is further configured to calculate phase mass flow rates of the multiphase fluid through a second section of the wellbore at least based on an average temperature in the second section, an average speed of sound in the second section, the estimated pressure, and a difference between a second known pressure at a second known-pressure location in the wellbore and the estimated pressure, wherein the second section is below the section and includes at least one producing zone of the wellbore.

13. The system of claim 12, wherein the computing device is further configured to calculate the phase mass flow rates of the multiphase fluid through the second section at each iteration of calculating the phase mass flow rates of the multiphase fluid through the section and the total mass flow rate of the multiphase fluid through the section.

14. The system of claim 12, wherein the second known pressure is a bottom hole pressure of the wellbore.

15. The system of claim 12, wherein the second section is above at least one other producing zone of the wellbore.

16. The system of claim 12, wherein the computing device is further configured to determine a zonal inflow in the section by performing a mass balance calculation based on the phase mass flow rates of the multiphase fluid through the section and the phase mass flow rates of the multiphase fluid through the second section of the wellbore.

17. The system of claim 16, wherein determining the zonal inflow in the section comprises performing a flash calculation based on the phase mass flow rates of the multiphase fluid through the second section at average conditions in the section.

18. The system of claim 12, wherein the computing device is further configured to determine a zonal inflow in the second section by performing a mass balance calculation based on the phase mass flow rates of the multiphase fluid through the second section and phase mass flow rates of the multiphase fluid through a third section of the wellbore, wherein the third section is below the second section and includes at least one other producing zone.

19. The system of claim 11, wherein the section of the wellbore is an entirety of the wellbore and the estimated pressure is a bottom hole pressure of the wellbore.

20. The system of claim 11, wherein the computing device is further configured to:
calculate phase mass flow rates of the multiphase fluid through a second section at least based on an average temperature in the second section, an average speed of sound in the second section, a second estimated pressure at a second estimated-pressure location in the wellbore that is different from the estimated-pressure location, and a difference between the known pressure and the second estimated pressure; and
calculate a total mass flow rate of the multiphase fluid through the second section based on the phase mass flow rates of the multiphase fluid through the second section, wherein the phase mass flow rates of the multiphase fluid through the second section and the total mass flow rate of the multiphase fluid through the second section are calculated iteratively by adjusting the second estimated pressure until the total mass flow rate through the second section is within a second threshold value of the known total mass flow rate of the multiphase fluid.
